(19) United States
(12) Patent Application Publication
(10) Pub. No.: US 2019/0266542 A1
(43) Pub. Date: Aug. 29, 2019

(54) SYSTEM FOR INTEGRATING WORK FORCE MANAGEMENT AND REMEDIAL TRAINING

(71) Applicant: Society of Cable Telecommunications Engineers, Inc, Exton, PA (US)

(72) Inventors: Mark Dzuban, Elverson, PA (US); Christopher Bastian, Glenmoore, PA (US); David Edmunds, Chester Springs, PA (US); Margaret Bernroth, Gulf Mills, PA (US)

(21) Appl. No.: 16/283,749

(22) Filed: Feb. 23, 2019

Related U.S. Application Data
(60) Provisional application No. 62/634,213, filed on Feb. 23, 2018.

(51) Int. Cl. G06Q 10/06

(52) U.S. Cl. CPC G06Q 10/06398; G06Q 10/06395

(57) ABSTRACT

The system for integrating work force management and remedial training is a combination of intelligent application data, graphics and analytic engines along with data and training database information concerning specific individuals and jobs (series of tasks). The system intelligently matches and dispatches individuals to complete jobs based on appropriate skills and competency level. If some skills are known to be deficient, the system can provide quick refreshers or tips sheets to the dispatched individual in a variety of ways. The system applications, engines and databases are updated dynamically as new events occur or as additional information becomes available. The system provides enhanced business data and metrics impacting workforce management and workforce investment.

### RELATED APPLICATIONS

This application claims the benefit of filing date of provisional application No. 62/634,213, filed on Feb. 23, 2018.

### FIELD OF THE INVENTION

The technology system relates to the continuous learning and development of any given workforce, in an industry, that is categorized with needing skilled workers with in-depth knowledge to create expert high performers who deliver measurable business results.

### BACKGROUND OF THE INVENTION

The invention automates remedial or specialized training and professional development of skilled workers performing multifaceted, complicated and varied tasks and aims to document and improve performance and expertise over time.

The system relates to the continuous learning and development of any given workforce, in an industry, that is categorized with needing skilled workers with in-depth knowledge to create expert high performers who deliver measurable business results. The platform delivers customized, personalized, and optimized learning activities over time that stimulate multiple areas of the brain to build up complex webs of knowledge, as the individual develops deep expertise.

The disclosure of co-pending U.S. patent application Ser. No. 15/681,569, filed Aug. 21, 2017, published as US 2018/0053430 A1, and titled Method for Training and Development of Craft Skills is herein incorporated by reference.

### SUMMARY OF THE INVENTION

The present disclosure relates to a system for integrating work force management and remedial training and defines a method for intelligently handling a complex and diverse work force faced with multifaceted and varied tasks.

The system applies time-management, work force management and skill-based analytics to effectively accomplish jobs and to manage, develop and fortify skills of the workers.

The system enhances management of workers to optimize task completion, trouble resolution, improves customer support and increases return on investment. The system aims to improve business impacting decision making and to document and improve workforce performance and expertise over time by providing, aggregating and analyzing a variety of pertinent data from a multitude of sources.

### BRIEF DESCRIPTION OF THE DRAWINGS

FIG. 1 shows a system for integrating work force management and remedial training as an analytics-optimized engine that engages training resource information about a specific individual or sets of individuals and the job or series of tasks they are assigned to perform. The system dispatches job information and intelligent operational hints and practices to the computing device that the worker(s) use(s) to complete the assignment. As jobs are dispatched and completed, the system gathers and retains performance and completion data.

FIG. 2 shows an example of the system architecture for a system for integrating work force management and remedial training using a smart application along with an information repository and portfolio to drive communications through graphics and analytics engines. The engines drive data and metrics to and from human resources, training databases and a data warehouse application that can extract or post data to a variety of external resources. Using a variety of data and computing protocols the engines also post feedback to the smart application system. The external resources may include but are not limited to: websites, certification databases, educational institutions, training databases, standards organizations and others. Feedback and measurements may include but are not limited to: improved test results, improved customer support,
MTTA=Mean Time to Access Information,
MTTC=Mean Time to Complete,
MTTR=Mean Time to Repair, rework, leadership feedback and more.

FIG. 3 shows an example of process flow for a system for integrating work force management and remedial training that is alerted when the technician is available for work or a new position. The analytics engine engages with the work force management systems and matches jobs to the technician's skill levels. If necessary, training for future qualification is suggested. Even when a tech is qualified for the job, if their history shows a missed quiz question or practice related to the assigned role, job or task, the system can provide hints or information related to successful completion of one or more of the complex tasks related to the job.

### DETAILED DESCRIPTION

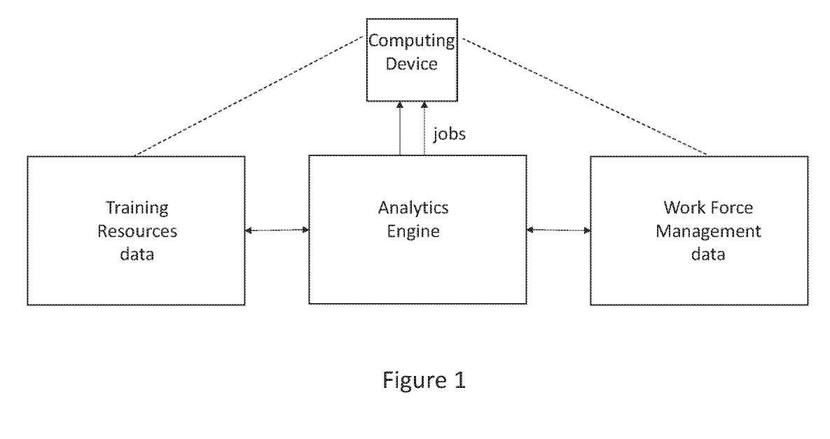

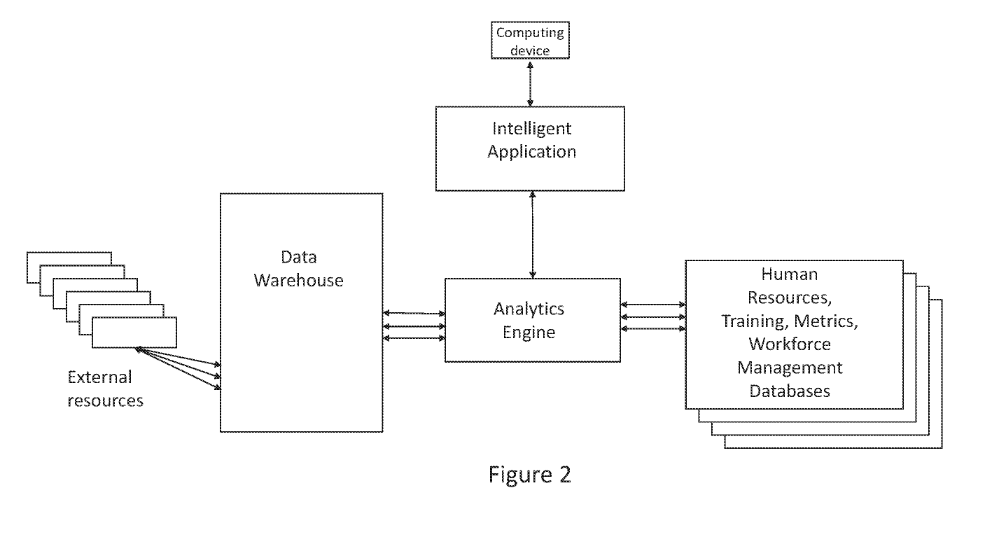

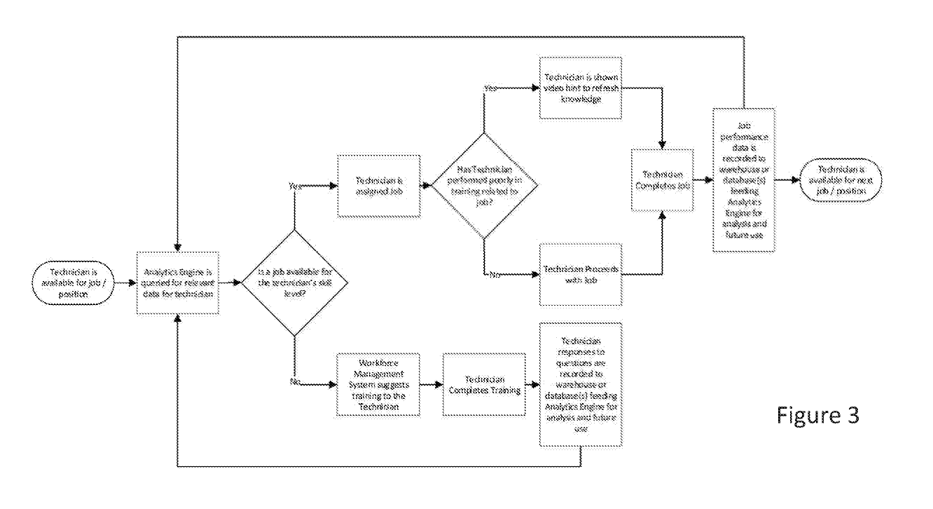

The work force management and/or time-management systems dispatch scheduled jobs to the assigned technician's computing device as shown in FIG. 1. An analytics engine optimizer is engaged that uses training resources like human resources databases, job skills knowledge databases, course statistics and scores, graphics and analytics to prompt pertinent information about the task(s) via a technology application on the technician's computing device as the job (series of tasks) progresses.

In the example of FIG. 2 there is shown an embodiment of system architecture and some functional components. The training resources database and or data warehouse contains but is not limited to:
Technician's training results,
User profile/history/transcript,
User's qualifications, certifications and areas of proficiency,
Training course statistics,
Career progression,
Technology equipment types,
Standards and operational practices,

The analytics engine can utilize:
Psychometrics analysis including the measurement of technician's
   knowledge
   abilities
   aptitudes
   personality traits

Pereto analysis examining data about:
the frequency of problems or their causes in the process of completing the assigned job
when there are many problems or causes and the worker is to focus on the most significant
when analyzing broad causes by looking at specific components

The intelligent application, the application information repository, and the application portfolio functions present data to the computing device.

The computing device data output may include:
business statistics,
specifications,
frameworks,
scores,
assessment results,
tips and hints,
self-service functionality, or
other customized output.

The data presented to the computing device may be from:
Intelligent application function and
compiled by the graphics and analytics engines functions from external or internal resources, databases, and/or data warehouses

The process flows in FIG. 3 are an example system that improves a knowledge base and updates the worker's skill-set based on successful or unsuccessful performance on the job or in the training environment. When the job is completed successfully, parameters in the technician's profile are updated to reflect the job's closeout. Example metrics may be employed (but not limited to) such as: time-to completion, verified success status, passing on retest, no subsequent dispatch within time limits, rework required, customer satisfaction, leadership feedback.

The system tracks measurement of performance and correlation to business impacting measures for corporations, businesses, departments, organizations, associations, societies, unions, etc., with reference to time-management and work force management. When the job is completed successfully, parameters in the work force or time management systems are updated to reflect the job's closeout. Parameters that are used include (but are not limited to): time-to completion, no subsequent dispatch within time limits, rework required, customer satisfaction etc. The parameters can be used for collection of business impacting performance data about the work and workforce, customer feedback, and costs to deploy successful products.

Also shown in FIGS. 2 and 3, the intelligent system contains smart applications, analytics and graphics engines, and a data warehouse along with access to employee/member training databases. The intelligent system sends hints and information including but not limited to: i.e.: “did you know . . . ?” about the specific job especially if the training database indicates that related material was previously incorrect or missed during training exercises. The information received at the technician's device may be (but is not limited to) audible, written, video or 3-dimensional rendering of cues, hints or operational practices to complete the job and improve their knowledge, skills and proficiency. Additionally, the system may capture and render transcripts of the individual's training or certifications.

The disclosed embodiments are illustrative, not restrictive. Other embodiments of the system may use unique or combined components other than the examples show in the figures. Functions may be provided via external existing or future resources and may use a variety of communications protocols and/or data interfaces. It is understood that the present invention can be applied to a wide variety of workforce management applications to collect business data and improve employee performance and expertise over time. There are many alternative ways of implementing the invention.

We claim:

1. A system for integrating work force management and remedial training of a technician, comprising:
a time-management and work force management system having
a computing device and
an intelligent application provided within the computing device,
the system presents information about the work to be performed and combines a job skills knowledge database associated with the technician's training skills and proficiencies, runs it through an analytics engine and offers information about the technician's job, series of tasks or other subject matter via an intelligent application on the computing device, and progresses as the technician's performance and expertise improve.

2. A system for integrating work force management and remedial training as in claim 1 wherein:
job skills knowledge database dynamically updates the technician's performance and skillsets based on successful or unsuccessful completion of the job or training material provided, wherein the updates comprise such information as transcripts, certifications, proficiencies and the system tracks overall performance as an investment in the technician's career.

3. A system for integrating work force management and remedial training as in claim 2 wherein the system:
tracks aggregate performance measures for corporations, businesses, departments, organizations, associations, societies, unions, and individuals' transcripts, and the system analyzes, correlates and presents data regarding business impacting measures by communicating with a variety of resources, resulting in improved business data for employers.

4. A system for integrating work force management and remedial training as in claim 5 wherein the system:
sends automated cues, including facts, remedial development material and operational practices to the technician during job performance, wherein such cues revolve around areas of unfamiliarity as well as areas where deficient performance was demonstrated during training, wherein an improved performance and expertise is created over time.
